(19) United States
(12) Patent Application Publication
(10) Pub. No.: US 2012/0298071 A1
(43) Pub. Date: Nov. 29, 2012

(54) COMBUSTION SYSTEM FOR INTERNAL COMBUSTION ENGINE

(75) Inventors: Munehisa Horibe, Chiryu-city (JP); Satoru Sasaki, Kariya-city (JP); Yoshiaki Nishijima, Toyokawa-city (JP); Takamasa Yokota, Kariya-city (JP)

(73) Assignee: DENSO CORPORATION, Kariya-city (JP)

(21) Appl. No.: 13/474,177

(22) Filed: May 17, 2012

(30) Foreign Application Priority Data
May 23, 2011 (JP) 2011-114389

(51) Int. Cl. F02M 25/00; F02M 69/04

(52) U.S. Cl. 123/299

(57) ABSTRACT

A combustion system of an internal combustion engine has a fuel injector injecting a fuel directly into a combustion chamber and a water injector injecting a water (non-combustible fluid) into the combustion chamber. The water collides with a fuel spray which the fuel injector injects. A penetrating force of the fuel spray is decreased and the fuel spray hardly reaches a cylinder wall surface. The injected fuel is combusted at a position away from the cylinder wall surface, so that the combustion heat transferred to the cylinder wall surface is reduced and the heat loss of the combustion can be decreased.

### CROSS-REFERENCE TO RELATED APPLICATION

This application is based on Japanese Patent Application No. 2011-114389 filed on May 23, 2011, the disclosure of which is incorporated herein by reference.

### TECHNICAL FIELD

The present disclosure relates to a combustion system of an internal combustion engine. In this system, fuel and non-combustible fluid (for example, water) are injected into a combustion chamber of the engine.

### BACKGROUND

JP-2008-175078A, JP-2009-138661A and JP-8-144771A disclose a combustion system in which fuel and water (non-combustible fluid) are injected into a combustion chamber of an internal combustion engine. In this system, the injected water vaporizes and expands in the combustion chamber, so that its expansile force is applied to a piston. That is, a part of heat loss, which increases exhaust gas temperature, is utilized as expansion energy of water, so that fuel economy is improved.

However, the vaporization expansile force of water is not large enough and an advantage of improving fuel economy is not always obtained.

### SUMMARY

It is an object of the present disclosure to provide a combustion system of an internal combustion engine in which fuel and non-combustible fluid are injected into a combustion chamber and a heat loss is decreased so that fuel economy is improved.

According to the present disclosure, a combustion system includes: a fuel injector injecting a fuel directly into a combustion chamber of an internal combustion engine; and a non-combustible fluid injector injecting a non-combustible fluid into the combustion chamber. The non-combustible fluid injector injects the non-combustible fluid in such a manner that a non-combustible fluid spray collides with a fuel spray which the fuel injector injects.

If non-combustible fluid is not injected as shown in FIGS. 2A and 2B, the fuel sprays “Jaf” and “Jbf” reach a cylinder wall surface. Then, as shown in FIG. 3A, the fuel spray is combusted at a vicinity of the cylinder wall surface. A combusted heat is transferred to the cylinder wall surface, which increases a heat loss.

According to the present disclosure, as shown in FIGS. 2C and 2D, since the non-combustible fluid spray “Jaw” and “Jbw” is formed to collide with the fuel spray “Jaf” and “Jbf”, a penetrating force of the fuel spray is decreased so that the fuel spray hardly reaches the cylinder wall surface. Thus, as shown in FIG. 3B, the injected fuel is combusted at a position away from the cylinder wall surface, so that the combustion heat transferred to the cylinder wall surface is reduced and the heat loss of the combustion can be decreased.

The injected non-combustible fluid is vaporized and expanded. Its expansile force is applied to a piston. Thus, a part of heat increasing the exhaust gas temperature is utilized as expansion energy of the non-combustible fluid, whereby the fuel economy is improved.

### BRIEF DESCRIPTION OF THE DRAWINGS

The above and other objects, features and advantages of the present disclosure will become more apparent from the following detailed description made with reference to the accompanying drawings. In the drawings:

FIG. 1A and FIG. 1B are construction diagrams showing an outline of an engine and a fuel combustion system according to a first embodiment;

FIG. 2A and FIG. 2B are construction diagrams showing a shape and a distribution of fuel spray in a case where no water is injected;

FIG. 2C and FIG. 2D are construction diagrams showing a shape and a distribution of fuel spray and water spray in a case where water is injected;

FIG. 3A and FIG. 3B are schematic diagrams for explaining a difference of a combustion position between a case where no water injection is conducted and a case where a water injection is conducted;

FIG. 4 is a flow chart showing a procedure of a fuel injection control and a water injection control according to the first embodiment;

FIG. 5A is a flowchart showing a processing of sub-routine of FIG. 4 according to the first embodiment;

FIGS. 5B and 5C are time charts showing a fuel injection command signal and water injection command signal according to the first embodiment;

FIG. 6A is a flowchart showing a processing of sub-routine of FIG. 4 according to the first embodiment;

FIGS. 6B and 6C are time charts showing a fuel injection command signal and water injection command signal according to a second first embodiment;

FIG. 7A, FIG. 7B, FIG. 7C, FIG. 7D, FIG. 7E and FIG. 7F are construction diagrams showing an outline of an engine and a fuel combustion system according to a third embodiment; and

FIG. 8 is a chart showing advance directions of a fuel spray and a water spray according to the other embodiment.

### DETAILED DESCRIPTION

Hereafter, embodiments of the present invention will be described. The same parts and components as those in each embodiment are indicated with the same reference numerals and the same descriptions will not be reiterated.

### First Embodiment

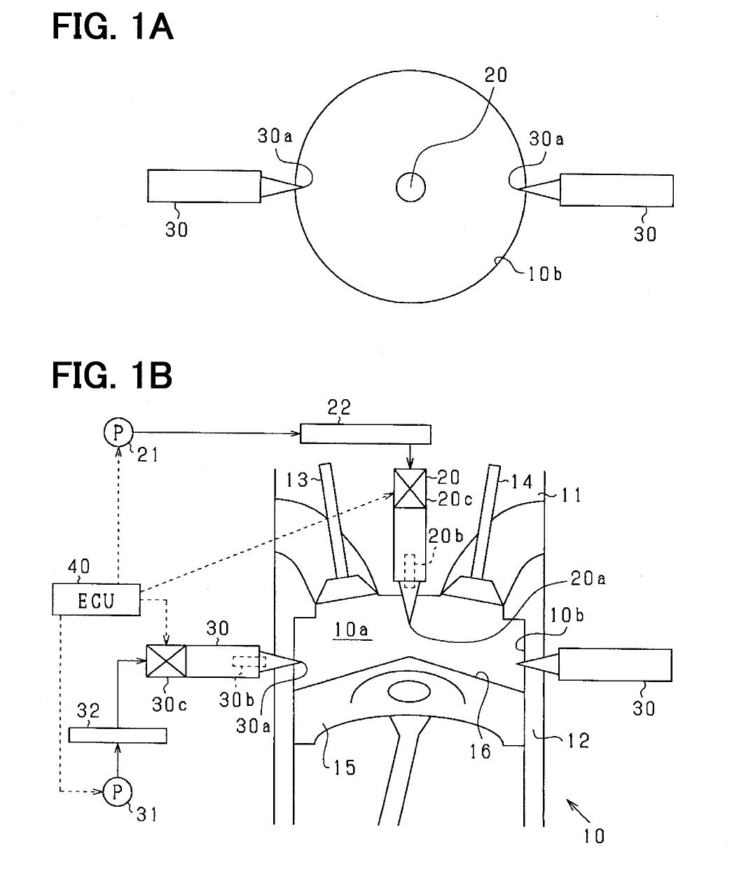

FIGS. 1A and 1B are schematic views showing a combustion system and an internal combustion engine (diesel engine) 10. The engine 10 has an intake valve 13 and an exhaust valve 14.

A fuel injector 20 is provided in a cylinder head 11 of the engine 10, and a water injector (non-combustible fluid injector) 30 is provided in a cylinder block 12 of the engine 10. FIG. 1A is schematic chart viewed from top of FIG. 1B to show positions of the fuel injector 20 and the water injector 30.

The fuel injector 20 is inserted into the cylinder head 11 in its axial direction. An injection port 10a is positioned in a combustion chamber 10a. Liquid fuel (for example, light oil) stored in a fuel tank is introduced into a common-rail 22 by a fuel pump 21. The accumulated fuel in the common-rail 22 is supplied to the fuel injector 20. In the present embodiment, the engine 10 has multiple cylinders each of which is provided with the fuel injector 20.

The fuel injector 20 is formed of a body having the injection port 20a, a valve 20b, and an electric actuator 20c. When an electronic control unit (ECU) 40 turns on the actuator 20c, the valve 20b is opened to inject the fuel into the combustion chamber 10a. When the ECU 40 turns off the actuator 20c, the valve 20b is closed to terminate the fuel injection.

Two water injectors 30 are inserted into a side wall of the cylinder block 12 in such a manner as to confront each other. Water (non-combustible fluid) stored in a water tank is introduced into a delivery pipe 32 by a water pump 31, and the accumulated high-pressure water in the delivery pipe 32 is supplied to the water injectors 30 provided in each cylinder.

It is preferable that the water supplied to the water injectors 30 is heated by a heater (not shown), such as a heat exchanger of the engine 10 and an electric heater.

Also, the water injector 30 is formed of a body having the injection port 30a, a valve 30b, and an electric actuator 30c. When an electronic control unit (ECU) 40 turns on the actuator 30c, the valve 30b is opened to inject the water into the combustion chamber 10a directly. When the ECU 40 turns off the actuator 30c, the valve 30b is closed to terminate the water injection.

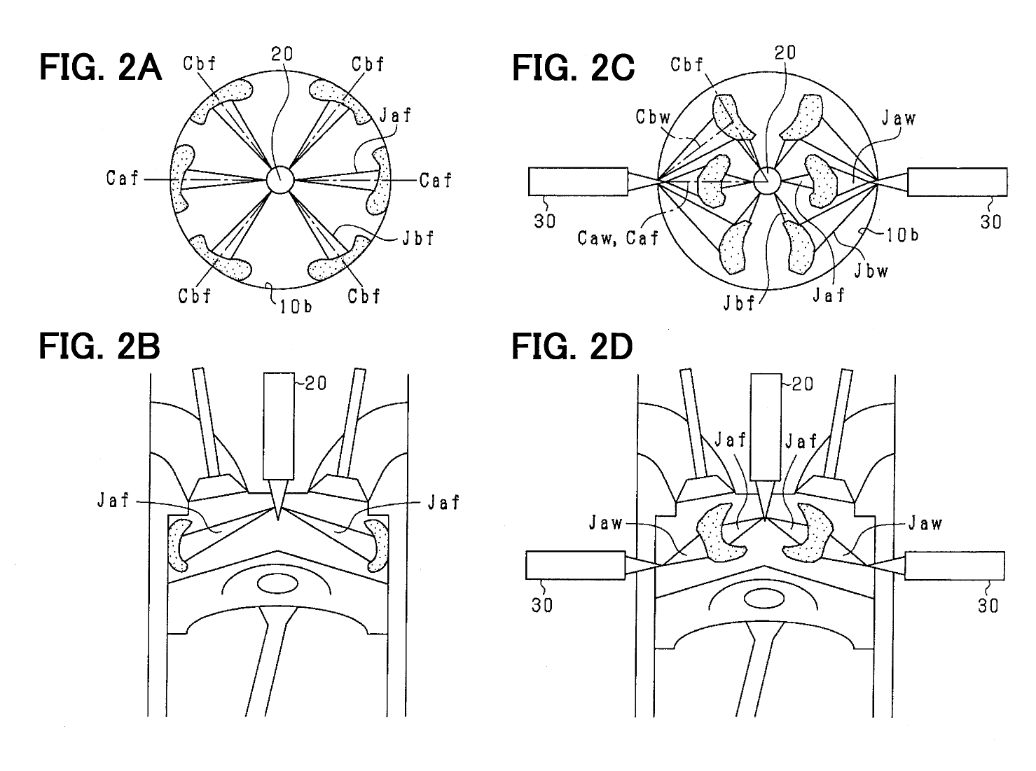

FIGS. 2A and 2B are schematic view showing a case where no water injection is conducted and the fuel injector 20 injects the fuel from the injection ports 20a. Its injected fuel sprays are denoted by “Jaf” and “Jbf” in FIGS. 2A and 2B. FIG. 2A is a schematic chart viewed from top of FIG. 2B. The fuel injector 20 has six injection ports 20a. A plurality of fuel sprays “Jaf” and “Lbf” are conical shape. Each injection port 20a is arranged equidistantly around a center axis of the fuel injector 20. FIGS. 2C and 2D are schematic view showing a case where the water injection and the fuel injection are conducted. The water injector 30 injects the water from the injection ports 20a. Its injected water sprays are denoted by “Jaw” and “Jbw” and the injected fuel sprays are denoted by “Jaf” and “Jbf” in FIGS. 2C and 2D.

The water spray collides with the fuel spray so that the fuel spray flows apart from the cylinder wall surface 10b. More specifically, the water spray collides with the fuel spray so that flow velocity of the fuel spray toward the cylinder wall surface 10b is attenuated. The fuel spray “Jaf” collides with the water spray “Jaw”. In other words, the fuel injector 20 and the water injectors 30 are arranged in such a manner that a center line “Caf” of the fuel spray “Jaf” coincides with a center line “Caw” of the water spray “Jaw”. Moreover, the fuel spray “Jbf” collides with the water spray “Jbw” from its side direction.

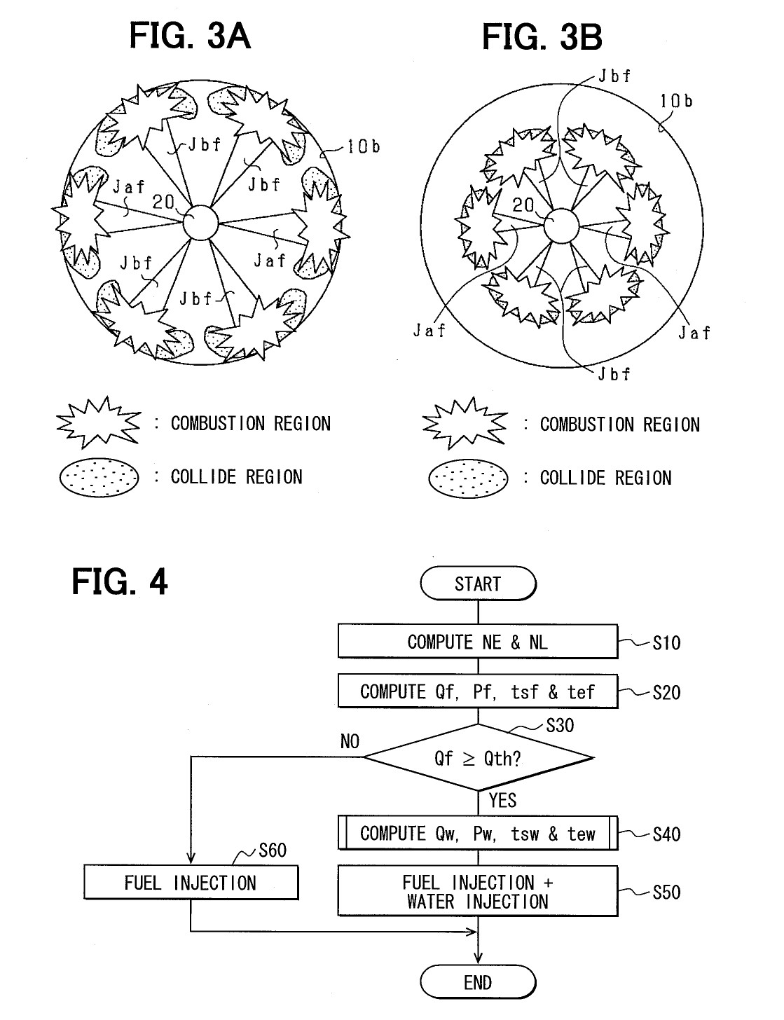

In other words, the fuel injector 20 and the water injectors 30 are arranged in such a manner that a center line “Cbf” of the fuel spray “Jbf” crosses a center line “Cbw” of the water spray “Jbw”. It should be noted that shaded portions in FIGS. 2A to 2D, 3A and 3B indicate positions where the fuel spray and the water spray collide with each other.

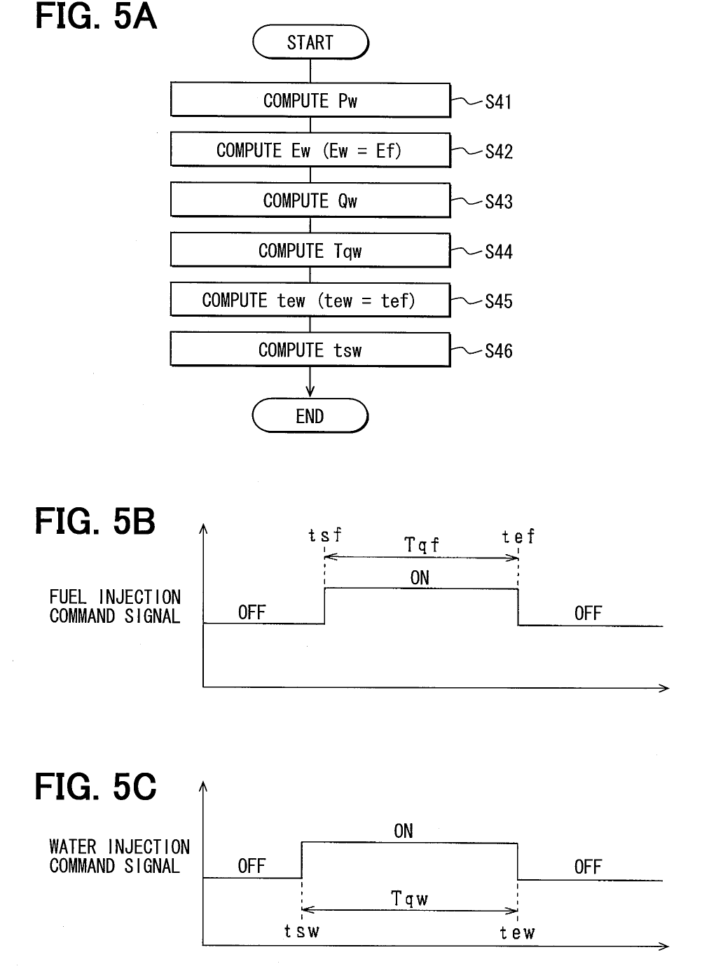

The ECU 40 has a microcomputer including a CPU and a memory to control the fuel injector 20 and the water injector 30. Specifically, the ECU 40 controls an injection start timing “ts” and an injection period “Tq”. By controlling the injection period “Tq”, an injection quantity “Q” per one injection is controlled. This control will be described later in detail, referring to FIGS. 4 and 5.

Furthermore, the ECU 40 controls a discharge quantity of the fuel pump 21 and the water pump 31 to control fuel pressure in the common-rail 22 and water pressure in the delivery pipe 32. Specifically, each of the fuel pump 21 and the water pump 31 is a plunger pump with a suction control valve which adjusts a suction quantity of the fuel or the water. The ECU 40 controls this suction control valve so that a fuel supply pressure “Pf” and a water supply pressure “Pw” are obtained.

The ECU 40 receives various detection signals indicative of engine speed NE, an accelerator position, and required engine torque. Based on these detection signals, the ECU 40 controls the fuel injector 20.

FIG. 4 is a flowchart showing a processing of the fuel injection control and the water injection control. This control processing is executed by a microcomputer which the ECU 40 includes. When an ignition switch is turned on, this processing is initiated and is repeated at a specified period or specified crank angle.

In Step S10, the computer computes the engine speed “NE” and the required engine load “NL”. In step S20, the computer computes target values of the fuel injection quantity “Qf” and the fuel supply pressure “Pf” based on the engine speed NE and the required engine load NL.

For example, the optimal fuel injection quantity and fuel-injection-start time “tsf” relative to the engine speed NE and the engine load NL are previously obtained by experiments. This relationship is stored in a map. In view of this map, the fuel injection quantity “Qf” and the fuel-injection-start time “tsf” are computed. Besides, it is preferable that the fuel injection quantity “Qf” is made larger as the engine load NL and the engine speed NE becomes higher.

There is a high correlation between an opening period of the valve 20b (injection period Tqf) and the injection quantity “Qf”. A fuel-injection-end time “tef” corresponds to a time after injection period “Tqf” elapsed from the fuel-injection-start time “tsf”.

The fuel supply pressure “Pf” is also computed in view of the map. It is preferable that the fuel supply pressure “Pf” is made larger as the engine load NL and the engine speed NE becomes higher. The ECU 40 controls the discharge quantity of the fuel pump 21 based on a target value of the fuel supply pressure “Pf”.

In step S30, the computer determines whether the computed fuel injection quantity “Qf” is greater than or equal to a specified value “Qth”. When the answer is YES, the procedure proceeds to step S40 in which water injection conditions are obtained according to a sub-routine shown in FIG. 5A. Then, the procedure proceeds to step 50 in which the fuel injector 20 and the water injectors 30 are operated under the obtained water injection condition. The fuel injector 20 is operated to perform a fuel injection which satisfies the fuel injection conditions “Qf”, “tsf” and “tef” computed in step S20.

Meanwhile, when the answer is NO in step S30, the procedure proceeds to step S60 in which the water injector 30 is not operated and only the fuel injector 20 is operated to perform a fuel injection which satisfies the fuel injection conditions “Qf”, “tsf” and “tef” computed in step S20

FIG. 5A is a flowchart showing a sub-routine of step S40 in FIG. 4. Based on the target fuel supply pressure “Pf” computed in step S20, the computer computes a target value of water supply pressure “Pw” in step S41. The pressure “Pf” and the pressure “Pw” are directly proportional to each other. The optimum “Pw” relative to “Pf” is previously obtained by experiment and stored in a map. Besides, it is preferable that “Pw” becomes higher as “Pf” becomes higher. In the present embodiment, it is controlled that the water supply pressure “Pw” is always lower than the fuel supply pressure “Pf”.

In step S42, the computer computes a kinetic energy “Ef” of the fuel spray injected from the fuel injector 20 based on “Qf” and “Pf” computed in step S20 (Ef=Qf×Pf). Then, a target kinetic energy “Ew” of the water spray injected from the water injector 30 is set to the same value as the kinetic energy “Ef”.

In step S43, the computer computes a target value of water injection quantity “Qw” based on “Pw” and “Ew”. For example, “Qw” satisfies “Ew=Qw×Pw”.

In step S44, the computer computes a water injection period “Tqw” based on the target values of “Pw” and “Qw”. Since the opening area of the injection port 30a is constant, the water injection period “Tqw” depends on “Pw” and “Qw”.

In step S45, the water-injection-end time “tew” is computed based on the fuel-injection-end time “tef”. Specifically, the time “tew” is established earlier than the time “tef”. In step S46, the computer computes the water-injection-start time “tsw” based on “tew” and “Tqw”. Specifically, the time “tsw” is set prior to the time “tew” by “Tqw”. That is, according to the processing shown in FIG. 5A, the kinetic energy “Ew” of the water spray becomes equal to the kinetic energy “Ef” of the fuel spray. Besides, it is prohibited to inject the water after the fuel injection is terminated.

FIGS. 5B and 5C are time charts showing output times of injection-command signals to the fuel injector 20 and the water injectors 30. In these charts, the water-injection-end time “tew” is set on the fuel-injection-end time “tef”. Furthermore, the water supply pressure “Pw” and the opening area of the injection port 30 are defined in such a manner that the time “tsw” is prior to the time “tsf”.

According to the present embodiment described above, following advantages can be obtained.

(1) Since the water sprays “Jaw” and “Jbw” are formed to collide with the fuel sprays “Jaf” and “Jbf”, a penetrating force of the fuel spray is decreased so that the fuel spray hardly reaches the cylinder wall surface 10b. Thus, as shown in FIG. 3B, the injected fuel is combusted at a position away from the cylinder wall surface 10b, so that the combustion heat transferred to the cylinder wall surface 10b is reduced and the heat loss of the combustion can be decreased.

(2) Since the water is injected to collide with the fuel spray, it is expedited that the fuel spray can be well spread in the combustion chamber 10a. Thus, the fuel spray is equally distributed in the combustion chamber 10a, whereby a fuel combustion can be ideally conducted.

(3) In a conventional combustion system, a piston has a concave portion on its top surface to generate a tumble flow. Meanwhile, according to the present embodiment, since the fuel spray can be equally distributed in the combustion chamber 10a as described above, it is unnecessary to form a concave portion on a top surface of the piston. The piston 16 has a convex top surface as shown in FIG. 1B.

(4) Since the piston 16 is configured to have a convex top surface, a tope dead center of the piston 16 is not restricted with respect to the position of the water injectors 30.

(5) Since the kinetic energy “Ew” is equal to the kinetic energy “Ef”, the water injection quantity is neither excess nor insufficient.

(6) Since the water is injected into the combustion chamber 10a, the injected water is vaporized and expanded. Its expansile force is transferred to the piston 15. Thus, a part of heat increasing the exhaust gas temperature is utilized as an expansion energy, whereby the fuel economy is improved.

(7) The fuel injector 20 is disposed at a center of the cylinder head 11 and the water injectors 30 are disposed in the cylinder block 30. Thus, the water injectors 30 can be easily applied to a conventional engine having no water injectors.

### Second Embodiment

In the above first embodiment, the kinetic energy “Ew” is established equal to the kinetic energy “Ef”. After that, the water injection period “Tqw” and the fuel injection period “Tqf” are established equal to each other. In the second embodiment, the water injection period “Tqw” and the fuel injection period “Tqf” are established equal to each other, first. Then, the kinetic energy “Ew” is established equal to the kinetic energy “Ef”.

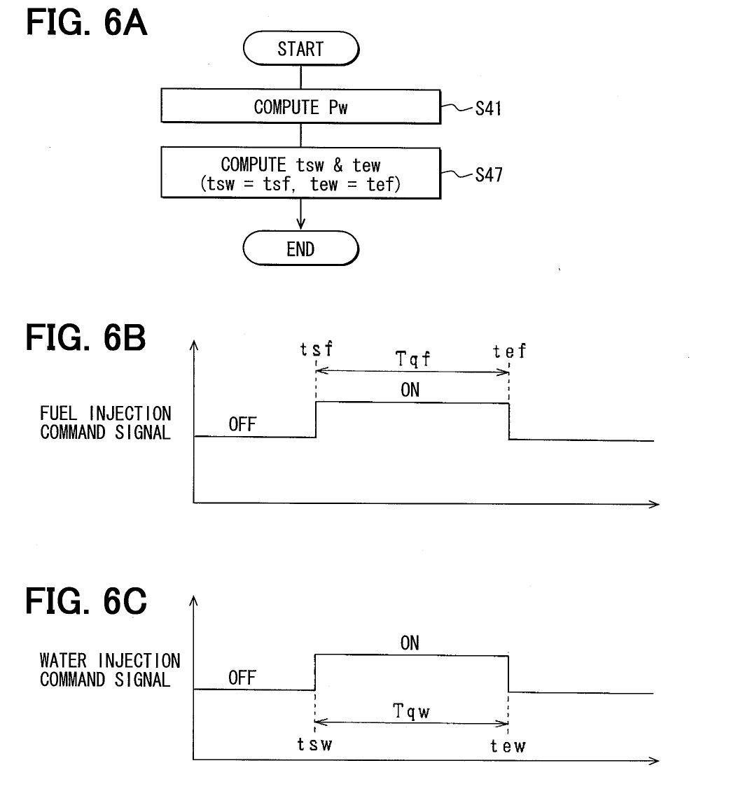

FIG. 6A is a flowchart showing a sub-routine of step S40 in FIG. 4. Based on the target fuel supply pressure “Pf” computed in step S20, the computer computes a target value of water supply pressure “Pw”.

In step S47, based on the fuel-injection-start time “tsf” and the fuel-injection-end time “tef”, the water-injection-start time “tsw” and the water-injection-end time “tew” are computed. That is, as shown in FIGS. 6B and 6C, the fuel-injection-start time “tsf” is equal to the water-injection-start time “tsw”, and the fuel-injection-end time “tef” is equal to the water-injection-end time “tew”. That is, the fuel-injection period “Tqf” is equal to the water-injection period “Tqw”.

According to the second embodiment, following advantages can be obtained besides the above advantages (1)-(4), (6) and (7) of the first embodiment.

(8) If a water injection is conducted prior to a fuel injection, it is likely that the water spray adheres to the fuel injector 20 before a fuel injection. According to the present embodiment, since the time “tsf” and the time “tsw” are same, it is less likely that the water spray adheres to the fuel injector 20 before a fuel injection.

(9) If the water is injected after the fuel injection is terminated, it is likely that excessive water which does no collide with the fuel may increase a heat loss. According to the present embodiment, since the time “tef” and the time “tew” are same, it is less likely that excessive water increase a heat loss.

(10) According to the present embodiment, since it is unnecessary to compute the kinetic energy “Ew” and “Ef” and the water-injection period “Tqw”, a processing load of ECU 40 can be reduced.

### Third Embodiment

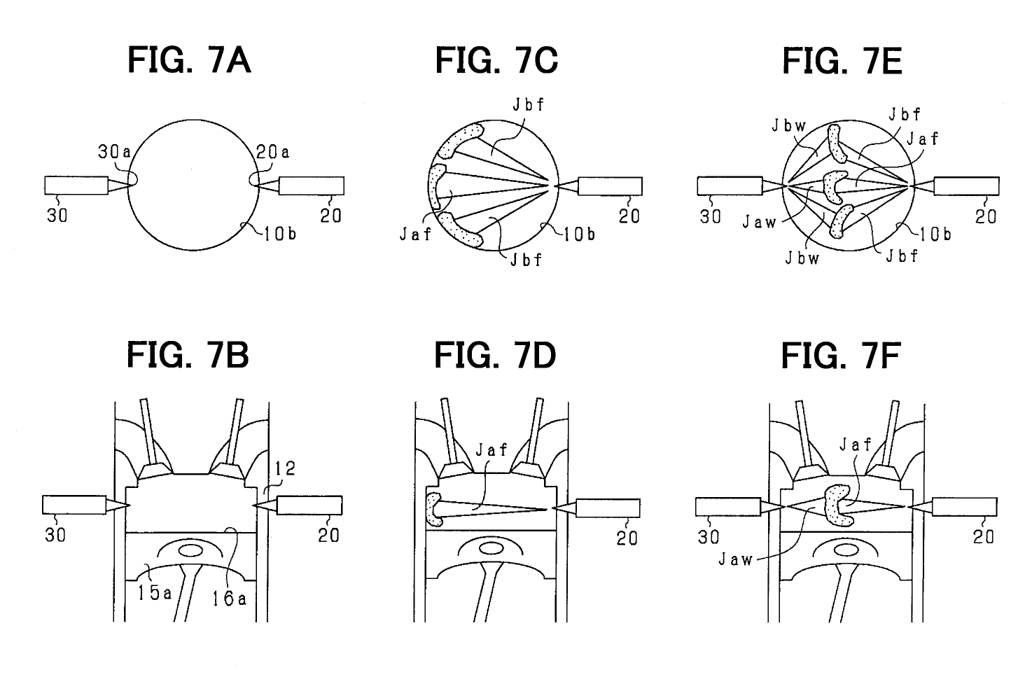

As shown in FIGS. 7A and 7B, the fuel injector 20 is provided in the cylinder block 12 to inject the fuel into the combustion chamber 10a in its radial direction.

FIGS. 7C and 7D are schematic views showing a case where no water injection is conducted and the fuel injector 20 injects the fuel from the injection ports 20a. Its injected fuel sprays are denoted by “Jaf” and “Jbf” in FIGS. 7C and 7D. FIG. 7C is a schematic chart viewed from top of FIG. 7D. The fuel injector 20 has three injection ports 20a. A plurality of fuel sprays “Jaf” and “Lbf” are conical shape. Each injection port 20a is arranged on a same plane. FIGS. 7E and 7F are schematic views showing a case where the water injection and the fuel injection are conducted. The water injector 30 injects the water from the injection ports 30a. Its injected water sprays are denoted by “Jaw” and “Jbw” and the injected fuel sprays are denoted by “Jaf” and “Jbf” in FIGS. 7E and 7F.

The fuel spray “Jaf” collides with the water spray “Jaw”. In other words, the fuel injector 20 and the water injector 30 are arranged in such a manner that a center line of the fuel spray “Jaf” coincides with a center line of the water spray “Jaw”. Moreover, the water spray “Jbw” collides with the fuel spray “Jbf” from its side direction. In other words, the fuel injector 20 and the water injector 30 are arranged in such a manner that a center line of the fuel spray “Jbf” crosses a center line of the water spray “Jbw”. It should be noted that shaded regions in FIGS. 7A to 7F indicate regions where the fuel spray and the water spray collide with each other.

According to the third embodiment, following advantages can be obtained besides the above advantages (1), (2), (5) and (6) of the first embodiment.

(3A) According to the present embodiment, since the fuel spray can be equally distributed in the combustion chamber 10a as described above, it is unnecessary to form a concave portion on a top surface of the piston. The piston 16 has a flat top surface as shown in FIG. 7B.

(4A) Since the piston 16 is configured to have a flat top surface, a tope dead center of the piston 16 is not restricted with respect to the position of the water injector 30.

(7A) The fuel injector 20 and the water injector 30 are provided in the cylinder block 12 in such a manner that the injection port 20a and the injection ports 30a confront each other. Thus, it is expedited that the fuel spray and the water spray collide with each other efficiently. In other words, the fuel injector 20 and the water injector 30 are arranged in such a manner that a center line of the fuel spray crosses a center line of the water spray with small cross angle. Thus, a penetrating force of the fuel spray can be decreased.

### Other Embodiment

The present invention is not limited to the embodiments described above, but may be performed, for example, in the following manner. Further, the characteristic configuration of each embodiment can be combined.

It is preferable that the opening area of the water injection port 30a is larger than that of the fuel injection port 20a. It is preferable that the water supply pressure “Pw” is lower than the fuel supply pressure “Pf”. Thereby, it is avoided that the water injection period “Tqw” becomes shorter than the fuel injection period “Tqf”. The fuel injection port 30a can be drilled with low cost. The kinetic energy “Ew” of the water spray and the kinetic energy “Ef” of the fuel spray can be made substantially equal to each other.

The fuel injector 20 and the water injector 30 may have single injection port 20a, 30a, respectively.

The water-injection-end time “tew” and the fuel-injection-end time “tef” may deviate from each other. However, it should be noted that the times “tew” and “tef” should be established in order to avoid a situation in which the water does not collide with the fuel spray and a situation in which the fuel does not collide with the water spray.

The water-injection-start time “tsw” and the fuel-injection-start time “tsf” may deviate from each other. However, it should be noted that the times “tsw” and “tsf” should be established in order to avoid a situation in which the water does not collide with the fuel spray and a situation in which the fuel does not collide with the water spray. Specifically, the time “tsw” is established prior to the time “tsf”. Alternatively, the water injection is started before the fuel spray reaches the cylinder wall surface 10b. For example, a time period required for the fuel spray to reach the cylinder wall surface 10b is previously obtained by experiments. The water injection is started before the required time period has elapsed after the time “tsf”.

Although the kinetic energy “Ew” and the kinetic energy “Ef” are established the same in the first embodiment, the kinetic energy “Ew” may be established larger than the kinetic energy “Ef”, whereby no fuel spray surely reaches the cylinder wall surface 10b.

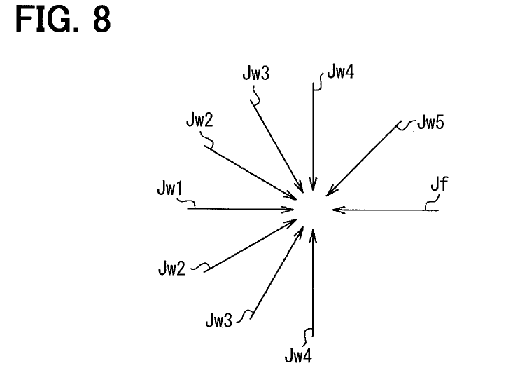

In FIG. 8, arrows represent advance directions of the fuel spray “Jf” and the water sprays “Jw1” to “Jw5”. The water sprays “Jw1” to “Jw4” decrease the penetrating force of the fuel spray “Jf”.

The water spray “Jw5” collides with the fuel spray “Jf” with acute angle. The water sprays “Jw1” to “Jw5” reduce the velocity of the fuel spray “Jf” heading to the cylinder wall surface 10b.

In FIG. 8, when it is assumed that the arrows correspond vectors indicating spray-advance directions and kinetic momentum, it is desirable that an inner product of vectors of the fuel spray and the water spray is zero or minus vector. Thus, it is expedited that the fuel spray “Jf” flows apart from the cylinder wall surface 10b.

What is claimed is:

1. A combustion system of an internal combustion engine, comprising:
a fuel injector injecting a fuel directly into a combustion chamber of an internal combustion engine; and
a non-combustible fluid injector injecting a non-combustible fluid into the combustion chamber, wherein:
the non-combustible fluid injector injects the non-combustible fluid in such a manner that a non-combustible fluid spray collides with a fuel spray which the fuel injector injects.

2. A combustion system of an internal combustion engine according to claim 1, wherein:
the non-combustible fluid injector injects the non-combustible fluid in such a manner that the non-combustible fluid spray collides with a fuel spray so that a velocity of the fuel spray toward an inner wall surface of the combustion chamber is attenuated.

3. A combustion system of an internal combustion engine according to claim 1, wherein:
the non-combustible fluid injector injects the non-combustible fluid in such a manner as to confront the fuel spray which the fuel injector injects.

4. A combustion system of an internal combustion engine according to claim 3, wherein:
the fuel injector and the non-combustible fluid injector are arranged in such a manner that a center line of the non-combustible fluid spray crosses a center line of the fuel spray in the combustion chamber.

5. A combustion system of an internal combustion engine according to claim 3, wherein:
the fuel injector and the non-combustible fluid injector are arranged in such a manner that a center line of the non-combustible fluid spray agrees with a center line of the fuel spray in the combustion chamber.

6. A combustion system of an internal combustion engine according to claim 1, wherein:
the non-combustible fluid injector starts to inject the non-combustible fluid before the fuel injector terminates a fuel injection.

7. A combustion system of an internal combustion engine according to claim 6, wherein:
the non-combustible fluid injector starts to inject the non-combustible fluid before the fuel spray reaches the inner wall surface of the combustion chamber.

8. A combustion system of an internal combustion engine according to claim 6, wherein:
the non-combustible fluid injector starts to inject the non-combustible fluid before the fuel injector starts to inject the fuel.

9. A combustion system of an internal combustion engine according to claim 1, wherein:
the non-combustible fluid injector is prohibited to inject the non-combustible fluid after the fuel injector terminates a fuel injection.

10. A combustion system of an internal combustion engine according to claim 1, wherein:
the non-combustible fluid injector injects the non-combustible fluid so that a kinetic energy of the injected non-combustible fluid becomes greater than or equal to a kinetic energy of the injected fuel.

11. A combustion system of an internal combustion engine according claim 10, further comprising:
a control portion which variably controls at least one of a pressure of the non-combustible fluid supplied to the non-combustible fluid injector and a non-combustible fluid injection period so that the kinetic energy of the injected non-combustible fluid becomes a target value.
